(19) United States
(12) Patent Application Publication
(10) Pub. No.: US 2012/0066095 A1
(43) Pub. Date: Mar. 15, 2012

(54) Method and Apparatus for Purchasing Gold and Other Precious Metals

(76) Inventors: Jason A. Wolter, San Diego, CA (US); Rudy Valdes, Bonita, CA (US); Aksel Chemitzky, Chula Vista, CA (US)

(21) Appl. No.: 12/880,637

(22) Filed: Sep. 13, 2010

(51) Int. Cl. G06Q 30/00

(52) U.S. Cl. 705/26.63

(57) ABSTRACT

A system and method for a buyer to purchase gold and gold bearing items from remote sellers. The system employs purchasers working with said buyer to seek gold bearing items from sellers. The sellers are provided with the price payable for their gold bearing item, before tendering it to the purchaser and are also afforded the ability to check gold prices before agreeing to a sale.

### FIELD OF THE INVENTION

The disclosed invention relates to the field of purchasing of precious metals and jewelry from individuals. More particularly, it relates to a method of employing a network of dealer-buyers such as friends and acquaintances of individuals who might sell gold, to solicit and purchase gold and other forms of precious metals. They system allows the seller to deal with a familiar person and to know the value of the gold before losing possession of it.

### BACKGROUND OF THE INVENTION

Gold during traumatic economic times has always been considered a safe bet for an investment and for emergency currency. Gold is also a major component of jewelry and coinage which families tend to keep for sentimental value or because it is a good investment.

However, as easy as gold is to purchase in the form of jewelry, coins, and even in ingots or bars, the resale of gold and other precious metal is a different story. A private party not in the business when selling jewelry generally will visit a jeweler, pawn broker, gold refiner or scrap gold dealer, who is in the business and will purchase unwanted jewelry and the like occupying the back of a person's jewelry box. In general, such purchasers will buy and recycle the gold in a seller's jewelry or the like, but the price paid for the gold can vary drastically. This puts most individuals, inexperienced in the realm of selling precious metals, at a severe disadvantage.

Most gold buyers will pay the seller a price for gold bearing jewelry and the like based on the weight of its gold content, minus a handling fee. Once purchased, the dealer melts down the jewelry, extracts the gold, and sometimes some of the hardening agents, and then resells it or uses it for in house products.

However, the current mode of this system is rife with potential for fraud and short changing of the seller. In the mail-in type system, currently popular and advertised on TV, the seller must send in the jewelry to a central location by mail and then be told its value. Thus, the seller loses possession before finding out the true value, and before finding out how much they will be paid. For the seller, not the most encouraging mode of operation.

The price paid the seller is based on the gold content of jewelry which is indicated in karats. Solid gold jewelry is 24 karats. Lesser jewelry has less gold content and more of other metals and hardening agents. Gold buyers will conventionally only pay for gold, and they determine both the amount present in a piece of jewelry, and the current price they will pay. The seller, being unfamiliar with this process, is on the wrong end of the bargaining table.

Generally, the gold content of any piece of jewelry will be marked on it somewhere such as on the inside of a ring or bracelet and on the clip of a necklace or the back of an earring. For instance, a 14-karat piece of jewelry may actually have “14 karat” inscribed on it in tiny lettering or the lettering may say “14/24” or “14K.” The less gold content in a piece of jewelry, the less money it will be worth to anyone who intends to melt it down. When you buy jewelry in the store, you are paying for the design and craftsmanship, as well as any precious and semi-precious stones that may be a part of the piece.

As a consequence, in times where the economy is in recession or trouble, people who sell jewelry for the gold value, are always potential victims of fraud, or just payment for their gold at too low a rate. These sellers are vulnerable in that they do not know how the system works, or how to determine the current price of gold, or how to determine the amount and type in their jewelry. Further, they generally are dealing with persons or vendors who are unknown to them and being put in position to trust such buyers.

As such, their exists an unmet need, for a system and method for the repurchasing and recycling of gold and other precious metals, from individual sellers who are unfamiliar with the process and the people involved. Such a system should provide a reasonable education for the seller, as to the amount, and daily current value of the gold in their jewelry so they may ascertain what a reasonable selling price is for their gold. Such a system should enable a large network of individuals, to act as buyers, who can work with family and friends, so as to provide a level of familiarity with the buyer, which is currently lacking.

It is thus an object of the invention to provide a system and apparatus which allows sellers of gold jewelry and the like, the ability to ascertain both the amount, and the current spot market value of the gold in the piece they are selling, during the transaction.

It is also an object of this invention to educate the seller of such gold and precious metals, with the value of gold on the day of the sale and provide the price the seller will be paid, before they tender possession of the jewelry or gold bearing metal to the dealer purchaser for the buyer.

It is a further object of this invention, to set up a system for a network of precious metal purchasers for a central buyer, in multiple geographic locations, each of which enabled to purchase gold from friends, acquaintances, referrals, and family, to add trust to the current system which lacks any by using persons known to the seller as buyers, and revealing the value and price to the seller before the sale.

These together with other objects and advantages which will become subsequently apparent reside in the details of the system and apparatus for gold purchasing and recycling herein and as more fully hereinafter described and claimed, reference being had to the accompanying drawings forming a part thereof.

### SUMMARY OF THE INVENTION

The system herein described, will enable a large number of individuals nationally, to become gold purchasers, and have a direct channel to forward purchased gold for recycling and thereby alleviate their need for inventorying purchased gold and the associated costs. By empowering individuals across the country to act as gold purchasers, the system will give many people who are unable to work full time, such as retired persons, or students and the like, the ability to be in their own businesses part time.

The formation of a network of hundreds and perhaps thousands of gold purchasers, and the provision of a channel for the flow of purchased gold, and remuneration to the dealer and to the seller directly, will also provide the sellers with great advantages over the current system. In addition, due to the transparency of the valuation, the disclosed method will encourage small sellers of jewelry and gold to visit the dealer purchasers since the seller is given the gold content, value based on daily international quotes, and the purchase price immediately. All this information is provided before the seller relinquishes possession of the gold to the dealer purchaser working for the buyer, unlike the conventional mode of such sales of precision metals.

Currently sellers of gold and precious metals, must either mail their jewelry to a firm advertising on television or the internet. Such firms are generally distant from the seller, and communication ends up occuring by long distance telephone, fax, or email. These sellers, with the gold out of their possession, must accept on faith, the state value of the precision metal and the price offered by the distant recipient company of the seller's package. The sellers must hope that the receiving firm, calculates the amount of gold, and purity correctly and honestly, and then accept this non transparent estimate for weight, by the distant buyer's estimate of the value on a given day.

Alternatively, sellers may try to visit a local jeweler or pawn shop, but with much of the same consequences. Such shops conventionally do not test for gold content in the presence of the seller nor do they provide an up to the minute spot price of gold, based upon which the seller is offered a price for their metal.

The system herein alleviates this potential for fraud and underpricing and possible non payment to the seller. In a first step, individual dealer purchasers will obtain a starter kit from the national buyer for the gold and will be provided an access code for their computer, or preferably their smart phone, to communicate with the buyer's server. The kit will include a plurality of acid-based chemicals, each of which adapted to react to the presence of gold visually, and provide visual means to ascertain the specific percentage of gold to other metals in the test sample. The chemicals, when employed, thus provide a visual means for the seller, and the buyer, to discern the purity of the gold. In combination with a weight of the sample, the exact amount of gold can be ascertained.

In testing a small amount of metal is filed from the jewelry or other piece of precious metal. In a second step, one of the plurality of provided test chemicals is dropped on the shavings. Once in contact with the metal shavings the chemical's color visually changes in the presence of gold in the shavings and vary depending on the particular percentage of gold by weight or carat rating. Currently, the device provides chemicals for tests for four carats, those being 10 carat, 14 carat, 18 carat, and 22 carat gold.

In use, the chemical testing of the metal shavings, provides the dealer purchaser and the buyer an immediate alert as to the content or carat of the sample by the liquid reacting with a color change, or another visually discernable reaction. The reaction may be with no color change of a clear liquid test chemical, or a color change for example to red in the presence of the proper carat rating of the shavings.

Also provided is a scale which is adapted to calculate the contained or actual gold content by weight of an item, based upon the determined purity or carat rating of the shavings of the jewelry being weighed. The scale may be an actual scale with a readout, which is used in conjunction with a calculator to determine the value of the gold in the piece. Once weighed, the determined purity of the gold from the first step is input, and the actual gold by volume or weight is calculated. Thereafter the dealer purchaser employs their access code to communicate with the buyer's server wherein the current spot market or other international value for gold, as of that day or hour, is ascertained. Thereafter, using the value communicated from the buyer's server, the amount of gold discerned in the jewelry or metal piece is multiplied by the valuation from the buyer's server, and the determined value of the jewelry presented by gold weight, is discerned and displayed to the dealer purchaser and/or the seller.

The seller, is thus armed with the knowledge of the purity, and the gold weight, and the current gold value based on the spot market or other pricing determiner. Thereafter, before giving up possession of the jewelry, the seller is given the exact amount of money they will receive if they sell the piece, and allowed to input a means for communication of the funds to their possession. Currently, a wire transfer, or credit to a web-based payment system such as PAYPAL is anticipated as preferred since it allows for a direct communication of funds, almost instantly, to the seller, thereby increasing trust. The dealer purchaser is also provided their commission information whereafter those funds are transmitted in the same fashion. This is a big departure from the current system where the seller must give up possession of the jewelry to a distant buyer and hope they get paid and are told the actual gold content of the jewelry.

Another preferred mode of the system, would be a scale communicating across a network such as the internet directly, or through a local computer, with a distant server. Once the dealer inputs their access code, the server for the buyer provides the current, up to the minute, price for gold on the international market to the communicating computer or scale if adapted to so communicate. The scale and/or engaged computer, employing software adapted to the task, determines the gold portion of the jewelry, based on the input of the chemical-determined purity from the aforementioned testing of shavings. Software would then ascertain through the server, the current value of the gold based on the international price for gold at the minute. The seller of course would be able to view all of this before giving up possession of the jewelry, and may be given their selling price before giving up possession of the jewelry. That price, of course, being based on actual viewed testing and the current price for gold on the international market.

Remuneration to the seller and the dealer purchaser is communicated preferably electronically as noted above, and insures monetary safety to the seller because the seller is informed of the amount of payment, before they have to give up possession of the item. Additionally, the dealer purchaser working downstream of the buyer, is paid by the buyer directly and separately from the seller.

Currently, the offered price is based on a percentage of the international spot market price of gold. Once the value of the piece is determined, the buyer is presented with a purchase price from the dealer purchaser which discounts the value based on processing and profit for the buyer. The seller is offered this set percentage of the purchase value and the dealer is given a predetermined set percentage of the total value of the piece based on the up to the minute spot price. Both are paid separately by wire transfer, or PayPal, or another secure payment system which keeps the seller's funds safe and separate from the dealer and vice-versa.

In this fashion, using this disclosed system, the seller possesses knowledge of the value of the piece they are selling, and the price the buyer will pay for it, before the seller gives up possession. In the payment phase, the seller is protected by direct payments to the seller and the dealer is protected by direct payments to the dealer thereby encouraging the dealer to continue selling to new clients since overhead is low, and payment is prompt.

These, together with other objects and advantages which will become subsequently apparent, reside in the details of the system and apparatus for advertising which provides revenue sharing herein and as more fully hereinafter described and claimed, reference being had to the accompanying drawings forming a part thereof.

### BRIEF DESCRIPTION OF DRAWINGS

FIG. 1 depicts a graphic of a flow chart of the system herein.

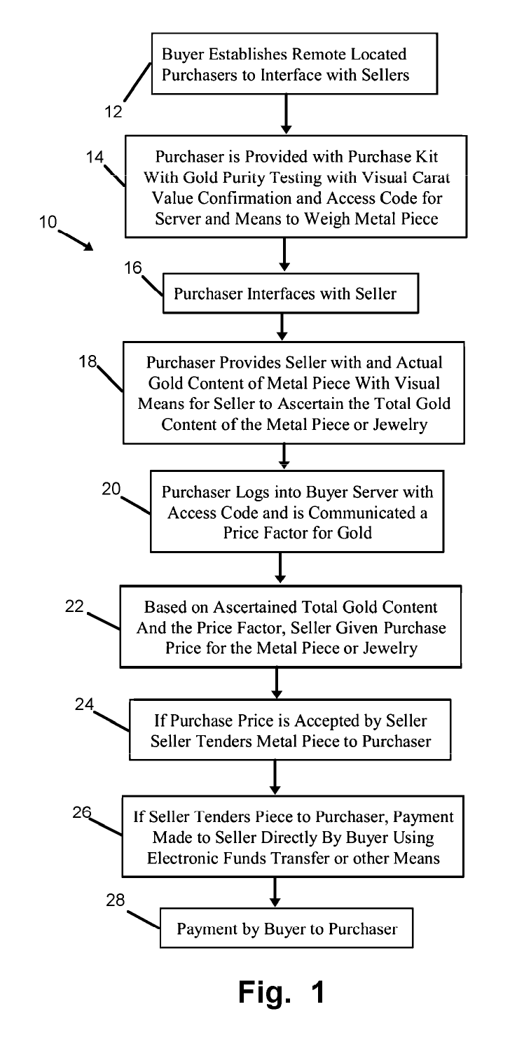

### DETAILED DESCRIPTION OF THE PREFERRED EMBODIMENT

Referring now to the drawings, wherein steps in the process are identified by like reference numerals, the disclosed system 10 for purchasing precious metals, more particularly gold, as noted, is configured to safeguard against the potential for fraud and underpricing in such sales.

In a first step a central buyer establishes one or a plurality of remote purchasers 12, to interface with sellers. Each purchaser will be provided a purchase kit 14 from the national buyer and will be provided an access code to communicate with the buyer's server. The kit, as noted, includes a plurality of acid based chemicals, each of which is adapted to react to the presence of gold visually to provide a visual means for the seller and purchaser to discern the purity of the gold. Thereafter the purchaser seeks and interfaces with sellers 16.

Upon reviewing a metallic piece or jewelry from a seller, the purchaser in a next step 18, removes by filing or other means, a small amount of metal from the seller's presented piece and employs the chemicals provide by the buyer, to provide visual means to discern the gold content of the piece by weight using chemicals provided and a scale. This visual means is currently a color change of the applied chemicals in the presence of gold in the shavings at a particular percentage by weight or carat rating. A current favored visual means to discern gold content provides individual test for gold content at a rate of 10 carat, 14 carat, 18 carat, and 22 carat gold based on the color of the applied chemical after reacting with the shavings.

In a next step 20 once the metal piece or jewelry is weighed, the determined for purity of the gold the purchaser employs their access code to communicate with the buyer's server wherein the current spot market or other international valuation factor for gold, as of that day or hour, is ascertained, and the seller is given a purchase price the buyer will pay for the metal piece or jewelry based on that valuation factor 22.

The purchaser knowing this purchase price offered in a next step 24 may accept the offered purchase price and tender the piece or jewelry to the purchaser. If the piece is tendered to the purchaser, a payment step 26 is executed and the seller is paid the purchase price preferably by electronic funds transfer. Finally, the purchaser is paid a percentage 28.

In a preferred mode of the system 10, the provision of the purchase kit 14, would include a scale communicating across a network such as the internet directly, or through a local computer, with a distant server. Once the dealer inputs their access code noted above, the current, up to the minute, price for gold on the international market to the communicating computer or scale if adapted to so communicate. The scale and/or engaged computer, employing software adapted to the task, determines the gold portion of the jewelry, based on the input of the chemical-determined purity from the aforementioned testing of shavings from the step in 18 and software is employed to ascertain through the server, the current actual value of the gold based on the international price for gold at the minute from which the seller is offered the purchase price.

While all of the fundamental characteristics and features of the improved disclosed method and apparatus for purchasing valuable metals such as gold, with reference to particular embodiments thereof have been shown and described, a latitude of modification, various changes and substitutions are intended in the foregoing disclosure and it will be apparent that in some instance, some features of the invention will be employed without a corresponding use of other features, or steps may be rearranged for operations, without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A method for a buyer to purchase gold and metals including the steps of:
establishing a plurality of individual purchasers working under said buyer;
providing metal assay kits having a viewable result representative of an aggregate gold content from sampled metal, to each said purchaser;
having said purchasers to seek gold bearing items from sellers;
having a said purchaser employ said assay kit to ascertain said gold content of a respective said gold bearing items presented by a said seller;
allowing said seller to see said viewable result of said gold content of said gold bearing items;
employing a networked communication device to communicate with a server operated by said buyer;
communicating said gold content to said server with said communication device;
employing software on said server to determine a current market price for gold;
employing said software to multiply said gold content by said current market price to ascertain a market value for said gold bearing items;
employing said software to deduct a buyers portion from said market value and thereby determine a payment amount;
communicating from said server, to a display viewable by said seller, said payment amount payable to said seller for said gold bearing items;
allowing said seller to accept or decline said payment amount;
if accepted, allowing said seller to tender to said gold bearing items to said purchaser;
tendering said payment amount to said seller from said buyer; and
tendering a commission payment to said purchaser from said buyer, whereby said seller and said purchaser are paid separately by said buyer.

2. The method of claim 1 comprising the additional steps of:
communicating an access code to said purchaser; and
requiring said purchaser to communicate said access code to said server prior to allowing said networked communication device to communicate with said server.

3. The method of claim 1 comprising the additional steps of:
allowing said seller to identify a financial institution where said seller has an account;
employing means for an electronic tendering of said payment amount to said account; and whereby said seller is paid directly by said buyer through an electronic transfer of funds and thereby provided means of encouragement for additional sales of additional said gold bearing items.

4. The method of claim 2 comprising the additional steps of:
allowing said seller to identify a financial institution where said seller has an account;
employing means for an electronic tendering of said payment amount to said account; and whereby said seller is paid directly by said buyer through an electronic transfer of funds and thereby provided means of encouragement for additional sales of additional said gold bearing items.

5. The method of claim 1 including the additional steps of:
providing said purchaser with means to enable a smartphone or laptop computer to function as said display viewable by said seller; and
employing said display for communicating from said server, said payment amount to be tendered to said seller for said gold bearing items.

6. The method of claim 2 including the additional steps of:
providing said purchaser with means to enable a smartphone or laptop computer to function as said display viewable by said seller; and
employing said display for communicating from said server, said payment amount to be tendered to said seller for said gold bearing items.

7. The method of claim 3 including the additional steps of:
providing said purchaser with means to enable a smartphone or laptop computer to function as said display viewable by said seller; and
employing said display for communicating from said server, said payment amount to be tendered to said seller for said gold bearing items.

8. method of claim 4 including the additional steps of:
providing said purchaser with means to enable a smartphone or laptop computer to function as said display viewable by said seller; and
employing said display for communicating from said server, said payment amount to be tendered to said seller for said gold bearing items.

9. The method of claim 1 including the additional steps of:
employing the current international spot price for gold as said market price for said gold; and
allowing said seller to ascertain said current spot price for gold independently.

10. The method of claim 1 including the additional steps of:
employing the current international spot price for gold as said market price for said gold; and
allowing said seller to ascertain said current spot price for gold independently.
